(19) United States
(12) Patent Application Publication
(10) Pub. No.: US 2019/0310500 A1
(43) Pub. Date: Oct. 10, 2019

(54) DISPLAY PANEL, COLLECTIVE DISPLAY PANEL, AND METHOD OF MANUFACTURING DISPLAY PANEL

(71) Applicant: SHARP KABUSHIKI KAISHA, Sakai City (JP)

(72) Inventors: MASAHIRO YAMADA, Sakai City (JP); TSUYOSHI ARIKAWA, Sakai City (JP)

(21) Appl. No.: 16/371,682

(22) Filed: Apr. 1, 2019

(30) Foreign Application Priority Data
Apr. 4, 2018 (JP) 2018-072206

(51) Int. Cl. G02F 1/1339; G02F 1/1333; G02F 1/1368

(52) U.S. Cl. CPC G02F 1/1339; G02F 2001/136222; G02F 1/1368; G02F 1/13336

(57) ABSTRACT

A display panel includes a first substrate, a second substrate disposed opposite the first substrate while having a liquid crystal layer therebetween, a first seal portion formed from a first sealant containing a resin as a main component and disposed around the liquid crystal layer to bond the first substrate and the second substrate together and seal the liquid crystal layer between the first substrate and the second substrate, and a second seal portion formed from a second sealant containing a resin as a main component and having higher oxygen absorbability than the first sealant has and disposed on an outer peripheral side of the display panel than the first seal portion and between the first substrate and the second substrate.

### CROSS REFERENCE TO RELATED APPLICATION

This application claims priority from Japanese Patent Application No. 2018-72206 filed on Apr. 4, 2018. The entire contents of the priority application are incorporated herein by reference.

### TECHNICAL FIELD

The technology described herein relates to a display panel, a collective display panel, and a method for manufacturing the display panel.

### BACKGROUND

Conventionally, as an example of a display panel, a liquid crystal panel having a structure in which an active matrix substrate and an opposite substrate disposed across a liquid crystal layer from each other are bonded together by means of a seal portion composed of a sealant such as resin is known. In such a display panel, the liquid crystal layer is sealed between both the substrates with the seal portion, but, in a case where the display panel is stored in a non-energized state for a long period of time, oxygen intrudes into the seal portion from an outer periphery of the display panel and reacts with the seal portion, and impurity ions generated diffuse into the liquid crystal layer, which causes a problem that a spot occurs at a peripheral edge portion of the display panel.

Therefore, for example, patent document 1 cited below discloses a substrate having oxygen resistance improved by mixing a deoxidant into an adhesion layer when the display substrate is formed by bonding a preformed thin film device layer on to a plastic substrate by means of the adhesion layer.

In addition, for example, patent document 2 cited below discloses an electronic device in which intrusion of moisture is suppressed by covering an outer peripheral face of the sealant with a barrier layer.

[Patent Document 1] Japanese Unexamined Patent Application Publication No. 2005-202094

[Patent Document 2] Japanese Unexamined Patent Application Publication No. 2017-129799

The display substrate described in patent literature 1 aims to reduce water and/or oxygen penetrating the plastic substrate to intrude from a plate face of the display panel, but cannot mitigate the problem due to the impurity ions generated by oxygen intruding into the seal portion from a side face of the display panel.

In the electronic device described in patent literature 2, a side end face or the like of the display panel is covered with the barrier layer composed of an atomic layer deposition film such as hafnium oxide or tantalum oxide. Though this atomic layer deposition film is formed for the purpose of suppression of intrusion of moisture, even if it is possible to suppress the intrusion of oxygen from the display panel side face, it is difficult to say that the electronic device described in patent literature 2 is a universal technology because of requirement of a special raw material and/or processing apparatus for the formation of the atomic layer deposition film, requirement of addition of a much more complicated process as compared with a conventional display panel manufacturing process, and/or the like.

### SUMMARY

The technology described herein was made in view of the above circumstances. An object is to provide a display panel and a collective display panel in which intrusion of oxygen into the seal portion on the display panel side face is suppressed, without making the manufacturing process complicated.

A display panel of the technique described therein includes a first substrate, a second substrate disposed opposite the first substrate while having a liquid crystal layer therebetween, a first seal portion formed from a first sealant containing a resin as a main component and disposed around the liquid crystal layer to bond the first substrate and the second substrate together and seal the liquid crystal layer between the first substrate and the second substrate, and a second seal portion formed from a second sealant containing a resin as a main component and having higher oxygen absorbability than the first sealant has and disposed on an outer peripheral side of the display panel than the first seal portion and between the first substrate and the second substrate.

According to the configuration described above, since the second seal portion formed from the second sealant having higher oxygen absorbability than the first sealant has is disposed nearer to the outer peripheral side than the first seal portion is, oxygen reaching the first seal portion is reduced, and therefore intrusion of oxygen into the first seal portion is suppressed. Then, even if impurity ions are generated by oxygen intruding into the second seal portion, since the first seal portion is interposed between the second seal portion and the liquid crystal layer, diffusion of the impurity ions into the liquid crystal layer is suppressed. As a result, the occurrence of a spot due to oxygen intruding into the seal portion is suppressed, so that the occurrence of a defective product when the display panel is stored in a non-energized state for a long period of time can be reduced. Here, since the second sealant contains a resin as a main component like the first sealant, the second seal portion can be easily formed by the same process as the first seal portion is formed. The second sealant can be made to have high oxygen absorbability, for example, by adding an deoxidant for absorbing oxygen. In a case where a deoxidant is used, it is preferred that the concentration of the deoxidant contained in the first seal portion be lower than the concentration of the deoxidant contained in the second seal portion, and it is further preferred that the deoxidant be not contained in the first seal portion. This makes it possible to select the deoxidant without concerning about pollution of the liquid crystal layer due to migration of the deoxidant or the like since the second seal portion containing the deoxidant is not in contact with the liquid crystal layer, and the first seal portion in contact with the liquid crystal layer does not contain the deoxidant (or has a low deoxidant content).

It is to be noted that, in the configuration described above, the first seal portion and the second seal portion are not required to be provided independently of each other, and the first seal portion and the second seal portion may be formed as an integral seal portion. In such a case, an outer peripheral side (equivalent to the second seal portion) of the seal portion is configured to have higher oxygen absorbability than an inner peripheral side (a liquid crystal layer side, equivalent to the first seal portion) thereof has. In a case where the deoxidant is used, it is preferred that the concentration of the deoxidant contained in the inner peripheral side of the seal portion be low, and it is further preferred that the deoxidant be not contained at least in a portion in contact with the liquid crystal layer.

In addition, a collective display panel of the technology described herein includes a plurality of display panels contiguous to one another, and one of the display panels includes a first substrate, a second substrate disposed opposite the first substrate while having a liquid crystal layer therebetween, a first seal portion formed from a first sealant containing a resin as a main component and disposed around the liquid crystal layer to bond the first substrate and the second substrate together and seal the liquid crystal layer between the first substrate and the second substrate, and a third seal portion formed from a third sealant containing a resin as a main component and having higher oxygen absorbability than the first sealant has, the third seal portion being disposed between a first mother substrate including first substrates contiguous to one another and a second mother substrate including second substrates contiguous to one another, and the third seal portion being disposed around the plurality of display panels in a plan view.

According to the configuration described above, since the third seal portion is provided, intrusion of oxygen into the first seal portion is suppressed. Since the third seal portion is so formed as to surround the two or more display panels collectively in the collective display panel, the effect of suppression of oxygen intrusion into the first seal portion can be achieved for the two or more display panels by a single structure. For example, if the third seal portion having high oxygen absorbability is disposed along outer peripheral edges of the first mother substrate and the second mother substrate included in the collective display panel, intrusion of oxygen into the first seal portions of all the display panels formed in the collective display panel is suppressed. Therefore, as compared with a case where the second seal portion is provided for each display panel, the configuration and process can be simplified, and it is useful for long-term storage of the collective display panel itself before isolation of the display panels, or the like. It is to be noted that the third sealant can be made by adding a deoxidant for absorbing oxygen, and it is preferred that the third sealant contain a resin curable by an external stimulus of the same kind as the first sealant. It is also preferred that the third seal portion be so extended as to close between the first mother substrate and the second mother substrate and as to have a closed-ring-like shape as a whole all around the first seal portions in a plan view.

In addition, a method for manufacturing a display panel of the technology described herein includes a first sealant application step of applying a first sealant containing a resin as a main component on a first substrate so as to form a closed-ring-like shape in a plan view, a second sealant application step of applying a second sealant containing a resin as a main component and having higher oxygen absorbability than the first sealant has on the first substrate on an outer peripheral side of the first sealant, and a seal portion formation step of forming a first seal portion and a second seal portion by curing the first sealant and the second sealant, with a second substrate disposed opposite the first substrate that has the first sealant and the second sealant applied thereon and bonding the first substrate and the second substrate together.

According to the configuration described above, the display panel according to claim 1 can be manufactured by a simple process. In the above description, the first sealant application step and the second sealant application step may be performed in any sequence. That is, after the second sealant application step, the first sealant may be applied to an inner peripheral side of the second sealant. Alternatively, the first sealant and the second sealant may be applied simultaneously. Furthermore, in the seal portion formation step described above, the first sealant and the second sealant may be cured simultaneously, or either one of them may be cured ahead. It is preferred that the main component of the first sealant and the second sealant be a resin curable by the same external stimulus (for example, irradiation with UV having a specific wavelength, or the like) because the first seal portion and the second seal portion can be formed by curing both the sealants simultaneously only by giving a single external stimulus. This makes it possible to manufacture the display panel according to claim 1 only by adding the second sealant application step, as compared with a method for manufacturing a display panel having a conventional configuration. Moreover, it is further preferred that the main component of both the sealants be the same resin because material procurement and/or management is facilitated.

According to the technology described herein, it is possible to manufacture a display panel and a collective display panel having improved oxygen resistance by a simple process and to store them in a non-energized state for a long period of time while suppressing the occurrence of a defective product, thereby facilitating production management.

### BRIEF DESCRIPTION OF THE DRAWINGS

FIG. 1 is a schematic view showing an outline of a plane configuration of a liquid crystal panel according to a first embodiment.

FIG. 2 is a schematic view showing an outline of an A-A cross-section configuration of FIG. 1.

FIG. 3 is a schematic view showing an outline of a plane configuration of a collective liquid crystal panel 100 (illustration of a mother CF substrate is omitted).

FIG. 4 is a schematic view showing an outline of a plane configuration of a collective liquid crystal panel according to a second embodiment.

FIG. 5 is a schematic view showing an outline of a plane configuration of a liquid crystal panel according to a third embodiment.

### DETAILED DESCRIPTION

### First Embodiment

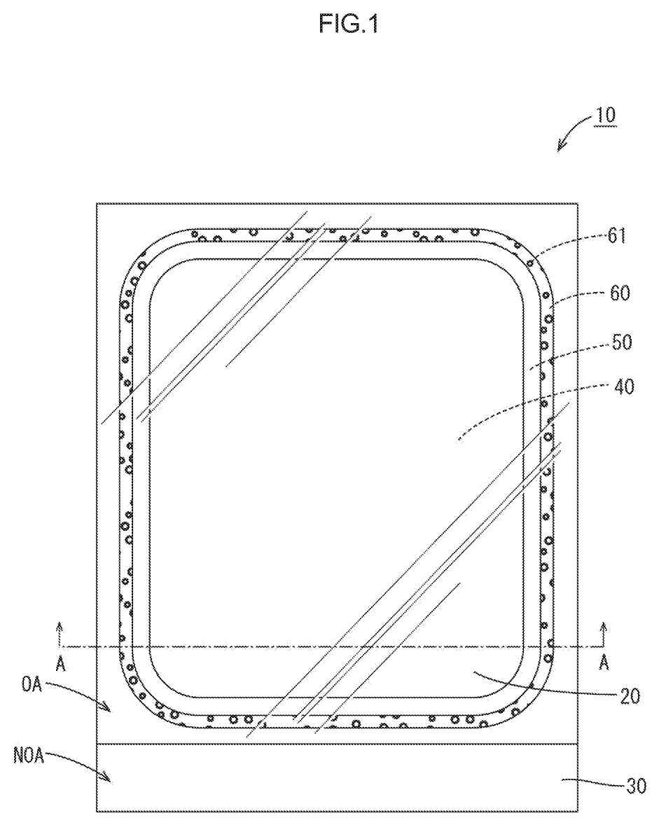

A first embodiment will be described with reference to FIGS. 1 to 3.

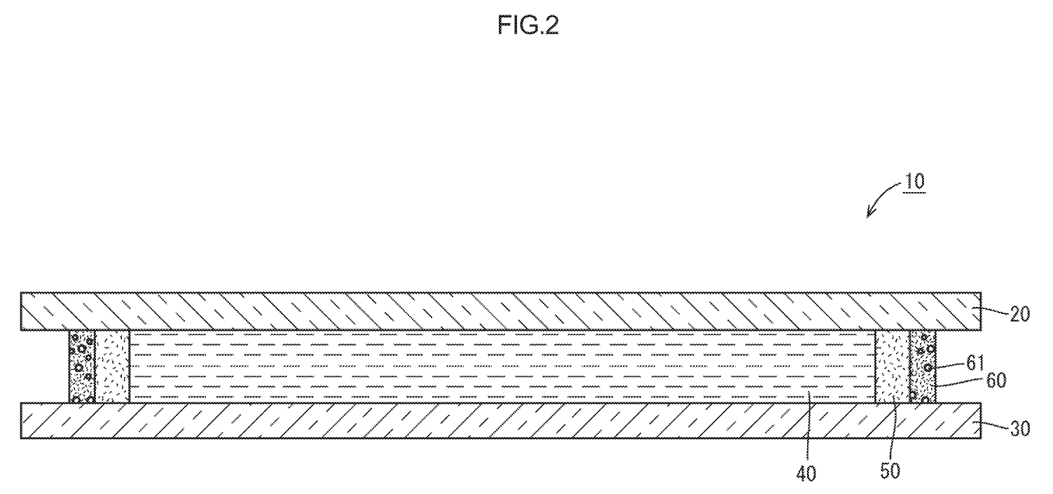

In the first embodiment, a liquid crystal panel (display panel) 10 provided in a liquid crystal display device is shown by way of example. It is to be noted that, hereinafter, an upper side in FIG. 1 is defined as top (a lower side as bottom) and a left side is defined as left (a right side as right), and an upper side in FIG. 2 is defined as front (a lower side as back), and that, for two or more same members, one of them may be denoted by a reference sign, whereas the reference sign to the other(s) may be omitted.

As shown in FIG. 1, the liquid crystal panel 10 according to the first embodiment has a vertically-long rectangular shape as a whole. Though not illustrated, a central portion of a plate face of the liquid crystal panel 10 is defined as a display area (active area) capable of displaying an image, whereas an outer peripheral portion having a substantially rectangular frame-like (bezel-like) shape in a plan view around the display area is defined as a non-display area (non-active area).

The liquid crystal panel 10 is provided with a pair of substrates 20, 30. Of the substrates 20, 30, the CF substrate (color filter substrate, opposite substrate: an example of a second substrate) 20 is located on the front side, and the array substrate (TFT substrate, active matrix substrate: an example of a first substrate) 30 is located on the back side. Lateral lengths of both the substrates 20, 30 are equal, whereas a vertical length of the CF substrate 20 is set smaller than a vertical length of the array substrate 30. The substrates 20, 30 are disposed opposite each other with their upper short sides aligned, an area near a lower short side of the liquid crystal panel 10 is defined as a substrate non-overlapping area NOA where the CF substrate 20 is not overlapping, and an area excluding the substrate non-overlapping area NOA is defined as a substrate overlapping area OA. It is to be noted that an entire area of the panel face of the CF substrate 20 is defined as the substrate overlapping area OA. The display area described above is formed within the substrate overlapping area OA, and an outer peripheral edge portion of the substrate overlapping area OA and an entire area of the substrate non-overlapping area NOA are the non-display area. A driving component for driving the liquid crystal panel 10 and/or a transmission component for transmitting an electrical signal for the driving are mounted on the substrate non-overlapping area NOA.

As shown in FIG. 2, the liquid crystal panel 10 is provided with, in addition to the pair of substrates 20, 30 described above, a liquid crystal layer 40 held between both the substrates 20, 30, a first seal portion 50 interposed between both the substrates 20, 30 to bond them together for sealing the liquid crystal layer 40 between both the substrates 20, 30, and a second sealing portion 60 disposed on an outer peripheral side of the first seal portion 50. In addition, a polarizing plate (not shown) is bonded to each of outer faces of both the substrates 20, 30. It is to be noted that FIG. 2 schematically shows an outline of a cross-section configuration of the liquid crystal panel 10, omits a part of the configuration, and also shows a part of an illustrated structure in a simplified manner.

Both the CF substrate 20 and the array substrate 30 are made by forming various films in a layered manner on an inner face side of a glass substrate made of glass.

Color filters having colored films of three colors, for example, R(red), G(green), and B(blue), arranged in a predetermined order repeatedly, a light-shielding film (black matrix: BM) disposed between the individual color filters and/or on a peripheral edge portion of the display area for preventing color mixture and/or light leakage, an overcoat film, a photospacer for retaining a predetermined space from the array substrate 30, and the like, are formed in a layered manner on an inner face side (a liquid crystal layer 40 side, an opposite face side to the array substrate 30) of the CF substrate 20 in the substrate overlapping area OA.

On an inner face side (a liquid crystal layer 40 side, an opposite face side to the CF substrate 20) of the array substrate 30 in the substrate overlapping area OA, a large number of TFTs (Thin Film Transistors: display element) which are switching elements and pixel electrodes are provided in a matrix-like arrangement, and gate lines (scan lines) and source lines (data lines, signal lines) (not shown) formed in a lattice-like shape are disposed around the TFTs and the pixel electrodes. The gate line and the source line are connected to a gate electrode and a source electrode, respectively, provided in the TFT, and the pixel electrode is connected to a drain electrode of the TFT. Once the TFT is driven on the basis of various signals supplied to the gate line and the source line, supply of a potential to the pixel electrode is controlled with the driving. In addition, a common electrode is so provided as to overlap with the pixel electrode, and once a potential difference occurs between these electrodes, a fringe field (oblique field) containing a component normal to the plate face of the array substrate 30 is applied to the liquid crystal layer 40. These structures are formed by layering various metal films, an insulating film, a semiconductor film, a transparent electrode film, and the like, sequentially on the glass substrate in a predetermined pattern by a photolithography method or the like.

On a front face side (a plate face side contiguous to an inner face) of the array substrate 30 in the substrate non-overlapping area NOA, terminals for connecting various electronic components mounted thereon are formed. Connection lines are formed in a routed manner between these terminals and each structure within the substrate overlapping area OA described above, and a surface of the substrate non-overlapping area NOA, excluding a portion where the terminal is formed, is covered with an insulating layer.

It is to be noted that, on each of innermost surfaces of the CF substrate 20 and the array substrate 30 in the substrate overlapping area OA, an orientation film is so formed as to hold the liquid crystal layer 40 from both sides. Both the orientation films have a function of orienting liquid crystal molecules contained in the liquid crystal layer in a fixed direction. The orientation film is made of, for example, polyimide, and formed as a light orientation film capable of orienting the liquid crystal molecules along a light irradiating direction by being irradiated with light in a specific wavelength range (for example, ultraviolet rays or the like).

The liquid crystal layer 40 is held between both the substrates 20, 30. The liquid crystal layer 40 contains the liquid crystal molecules which exhibit liquid crystallinity and have optical properties which vary with the application of the electric field, and covers the display area entirely and is also so disposed as to be slightly extended to an inner peripheral edge side of the non-displaying area. The liquid crystal molecules within the liquid crystal layer 40 are kept oriented in the fixed direction by the orientation film described above. Once the fringe field is applied by driving the TFTs, as described above, the oriented state of the liquid crystal molecules varies, and with this the state of light penetrating the liquid crystal panel 10 varies so that an image will be displayed on the display area.

The first seal portion 50 for sealing the liquid crystal layer 40 is also interposed between both the substrates 20, 30. The first seal portion 50 is composed of a first sealant containing a resin as a main component. The resin as a main component of the first sealant can be a resin curable by an external stimulus, for example, a photo-curable resin or a thermosetting resin. Of these, a photo-curable resin, in particular, a UV-curable resin is preferably used in view of operation management or the like. For example, an epoxy resin or a phenolic resin can be used. It is to be noted that the first sealant according to the first embodiment does not contain a deoxidant described later with respect to a second sealant.

As shown in FIG. 1, the first seal portion 50 is formed in a substantially rectangular frame-like (closed-ring-like) shape, as a whole, surrounding the liquid crystal layer 40 and extending all around the liquid crystal layer 40 along an outer peripheral end thereof in an outer peripheral end portion of the substrate overlapping area OA in plan view (as viewed in a direction normal to the plate face of both the substrates 20, 30). As shown in FIG. 2, the first seal portion 50 is interposed between the CF substrate 20 and the array substrate 30, and bonds both the substrates 20, 30 together, with a cell gap equal to a thickness of the liquid crystal layer 40 maintained, and seals the liquid crystal layer 40 between both the substrates 20, 30.

It is to be noted that the first seal portion 50 is provided when the CF substrate 20 and the array substrate 30 (alternatively, a mother CF substrate and a mother array substrate 130), which are individually separately manufactured, are bonded together in the manufacturing process of the liquid crystal panel 10, as described later, and is therefore in contact with an innermost face of a layered structure formed on the inner face side of each substrate, and located in an uppermost layer, in the outer peripheral end portions of the substrate overlapping areas OA of both the substrates 20, 30. It is to be noted that, in order to keep the cell gap uniform all over the liquid crystal panel 10, within the display area in a central portion of the substrate overlapping area OA, a photospacer may be interposed between both the substrates 20, 30.

In the liquid crystal panel 10 according to the first embodiment, the second seal portion 60 surrounding the first seal portion from the outer peripheral side is further provided between both the substrates 20, 30. The second seal portion 60 is composed of a second sealant containing a resin as a main component. The resin as a main component of the second sealant can be a resin curable by an external stimulus, for example, a photo-curable resin or a thermosetting resin, like the resin contained as a main component in the first sealant and, for example, an epoxy resin or a phenolic resin can be used. Though a resin different from the resin as a main component of the first sealant may be used for a resin as a main component of the second sealant, a case where the same UV-curable epoxy resin is used as a main component of the first sealant and the second sealant will be described by way of example in the first embodiment. The second sealant, unlike the first sealant, contains in the resin as a main component a deoxidant 61 for absorbing oxygen, and therefore has higher oxygen absorbability than the first sealant has. As a deoxidant 61, a known substance which easily combines with oxygen to absorb oxygen, whether metallic or organic, can be used. Specifically, a deoxidant containing active metal powder, such as titanium oxide, cerium oxide or iron, as a main agent, a deoxidant containing ascorbic acid as a main agent, a deoxidant containing glycerol or glycol as a main agent, a deoxidant containing sugar alcohol as a main agent, or the like, can be cited. It is preferred that the deoxidant 61 have, for example, a particle size within a range from 0.1 μm to 5.0 μm. If the particle size of the deoxidant 61 is outside this range, formability, adhesiveness, and/or the like, may degrade when the second sealant is applied with a sufficiently effective amount of the deoxidant 61 compounded in the resin contained as a main component. In addition, it is preferred that the deoxidant 61 have a specific gravity in a range from 1.0 g/cm³ to 8.0 b/cm³. If the specific gravity is outside this range, when a common epoxy resin or phenolic resin is used as a main component, it may be difficult to perform dispersion compounding of the deoxidant 61 in these resins successfully. If, for example, an iron-based deoxidant is used as a deoxidant 61, a compounding amount of the deoxidant 61 can be, for example, in a range of 4.0 wt % or more and 15.0 wt % or less with respect to a total amount of the second sealant. Such a range makes it possible to form the second seal portion 60 successfully without a defect while achieving a sufficient oxygen absorption effect.

Next, an example of a method for manufacturing a liquid crystal panel 10 thus configured will be described.

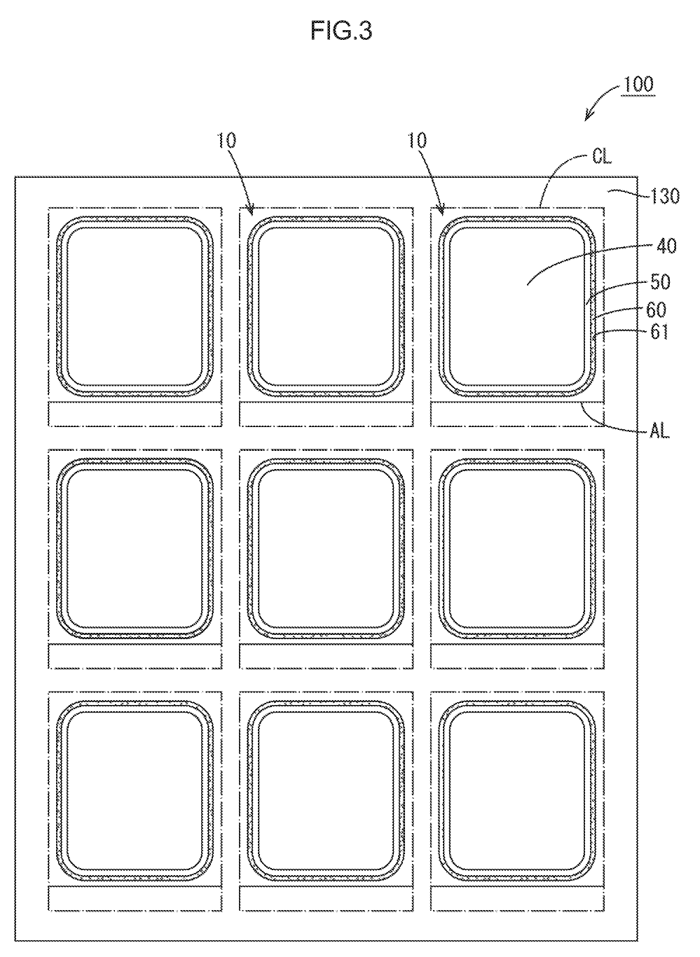

The liquid crystal panel 10 can be manufactured by a manufacturing method including a first sealant application step, a second sealant application step, and a seal portion formation step. Each step will be described below. It is to be noted that, as an example of the above manufacturing method, a manufacturing method will be described below where a collective liquid crystal panel 100 (an example of a collective display panel) composed of two or more liquid crystal panels 10 contiguous to one another is produced, and then a liquid crystal panel isolation step of dividing the collective liquid crystal panel 100 (an example of a display panel isolation step) is performed to obtain the liquid crystal panel 10. In such a method, a mother array substrate (an example of a first mother substrate) 130 composed of two or more array substrates 30 contiguous to one another and a mother CF substrate (an example of a second mother substrate) composed of two or more CF substrates 20 contiguous to one another are used. It is to be noted that, in FIG. 3, for the convenience of description, illustration of the mother CF substrate disposed on the front side is omitted, and a plane configuration of the collective liquid crystal panel 100 is schematically depicted.

In order to produce the collective liquid crystal panel 100, the mother array substrate 130 and the mother CF substrate are produced by performing pattern formation of a layered structure composed of various films described above at predetermined two or more locations on a transparent substrate. It is to be noted that, advantageously, an alignment line AL for defining the substrate overlapping area OA, the substrate non-overlapping area NOA, and the like, in the individual liquid crystal panel 10 and/or a cutting line CL for isolating each liquid crystal panel 10 are marked on the mother array substrate 130 and the mother CF substrate.

First of all, the first sealant is so applied on to the mother array substrate 130 as to extend slightly inside and all along an outer peripheral end of the substrate overlapping area OA of each array substrate 30 marked out by the cutting line CL and the alignment line AL (first sealant application step).

The first sealant according to the first embodiment, as described above with respect to the first sealant 50, contains a UV-curable epoxy resin as a main component, and prepared by compounding an initiator, a curing agent, a viscosity modifier, or the like, where appropriate. A method for applying the first sealant is not particularly limited, and the first sealant can be applied by any method such as application using an inkjet apparatus or a dispenser. A width of the first sealant to be provided is, for example, 150 μm to 1000 μm. Within such a range, it is possible to seal the liquid crystal layer 40 and also bond the array substrate 30 and the CF substrate 20 together with a sufficient adhesive strength while slimming down the bezel of the liquid crystal panel 10. Thereby, two or more first sealants are so applied as to form a substantially rectangular closed-ring-like (frame-like) shape as a whole with respect to the individual liquid crystal panels 10.

Next, a second sealant is so applied as to surround the two or more closed-ring-like first sealants applied on the mother array substrate 130, individually from their outer peripheral sides (second sealant application step).

The second sealant according to the first embodiment, as described above with respect to the second seal portion 60, contains a photo-curable resin as a main component, like the first sealant, and is prepared by compounding an initiator, a curing agent, a viscosity modifier, or the like, where appropriate, in addition to the deoxidant 61 described above. Various compounded materials, including the deoxidant 61, are mixed into the UV-curable epoxy resin as a main component by any method such as heating agitation. A method for applying the second sealant is not particularly limited, and the second sealant can be applied by any method such as application using an inkjet apparatus, a dispenser, or the like, but, in terms of simplification of manufacturing equipment and/or process management, it is preferred that the second sealant be applied by the same method as the first sealant. Furthermore, simultaneous application of both the sealants is preferred, such as drawing by injecting the first sealant and the second sealant simultaneously from nozzles provided together, since this can further simplify the manufacturing process. A width of the second sealant to be provided can be, for example, 150 μm to 1000 μm. Within such a range, it is possible to form the second seal portion 60, while slimming down the bezel of the liquid crystal panel 10, such that the second sealant surrounds the outer periphery of the first sealant without a gap left so that intrusion of air into the first seal portion 50 can be effectively suppressed. Thereby, the second sealant is so applied on to the outer peripheral side of the two or more first sealants applied in a closed-ring-like shape as to surround each first sealant. In the first embodiment, the second sealant is so applied as to have an inner periphery in contact with the outer periphery of the first sealant. Though applying the second sealant in contact with the first sealant before the first sealant is cured may cause the first sealant and the second sealant to be mixed at their interface to form an integral structure, such a case is acceptable. Though it is preferred in terms of slimming of the bezel that the first sealant and the second sealant be applied in close proximity to each other, the technology described herein is not limited thereto, and a gap may be present between the first sealant and the second sealant. In the case where a gap is present therebetween, the first seal portion 50 and the second seal portion 60 are formed as an independent structure from each other, consequently migration of the deoxidant and/or impurity ions from the second seal portion 60 to the first seal portion 50 is suppressed, and therefore their diffusion into the liquid crystal layer 40 is also effectively suppressed.

The second sealant according to the first embodiment is formed all around the first sealant. Though the second sealants according to each liquid crystal panel 10 are so depicted as to be independent of one another in FIG. 3, the technology described herein is not limited thereto. For example, the second sealant may be so applied as to extend from the outer peripheral side of the first sealant of one liquid crystal panel 10 to the outer peripheral side of the first sealant of another liquid crystal panel 10 adjacent thereto across the cutting lines CL, CL. Thereby, the second sealants surrounding the first sealants of the individual liquid crystal panels 10 collectively formed are made contiguous to one another on the mother array substrate 130, and when each liquid crystal panel 10 is isolated along the cutting line CL, as described later, the liquid crystal panel 10 having the second seal portion 60 embedded to an outer peripheral end face of the panel is obtained.

Next, a liquid crystal material constituting the liquid crystal layer 40 is given to the inner peripheral side of the first sealant. As a liquid crystal material, a known material can be used without any particular restriction, and the application method can also be any method using an inkjet apparatus, a dispenser, or the like, without any particular restriction.

Next, the mother CF substrate is positioned oppositely on the mother array substrate 130 having the first sealants and the second sealants applied at two or more locations, and the first sealant and the second sealant are cured to form the first seal portion 50 and the second seal portion 60 (seal portion formation step).

Specifically, the mother CF substrate is placed on the mother array substrate 130 with reference to the alignment line AL, or the like, marked thereon, and the first sealant and the second sealant are cured with both the substrates in close contact with each other. In the first embodiment, since the same UV-curable epoxy resin is used as a main component of both the sealants, by irradiation for a predetermined period of time with light having a wavelength effective to cure the resin, for example, UV having a predetermined wavelength, the first sealant and the second sealant are simultaneously cured to form the first seal portion 50 and the second seal portion 60, so that the mother array substrate 130 and the mother CF substrate can be bonded together.

In the above manner, the collective liquid crystal panel 100 having the liquid crystal panels 10 collectively formed and vertically and horizontally arranged is produced.

The collective liquid crystal panel 100 is provided with the mother array substrate 130, the mother CF substrate, the first seal portions 50 bonding both the mother substrates together and individually sealing the liquid crystal layers 40 disposed at two or more locations, and the second seal portions 60 so disposed as to surround the two or more first seal portions 50 individually. In the first embodiment, the first seal portion 50 and the second seal portion 60 both contain a UV-curable epoxy resin as a main component, and only the second seal portion 60 contains the deoxidant 61 for absorbing oxygen. The second seal portion 60 is so formed as to surround the first seal portion 50 entirely in plan view, and as to be in close contact with both the mother substrates to close a gap in cross-sectional view.

Next, each liquid crystal panel 10 is isolated from the collective liquid crystal panel 100 by cutting and dividing the collective liquid crystal panel 100 along the vertical and horizontal cutting lines CL (liquid crystal panel isolation step).

In this manner, the liquid crystal panel 10 according to the first embodiment is manufactured.

Now, in order to verify an advantageous effect achieved by providing the second seal portion 60 in the liquid crystal panel 10 according to the first embodiment, a period of time until oxygen was saturated in the second seal portion 60 and reached the first seal portion 50 under the following conditions i to iv was calculated.

i) The dimensions of the second sealant provided is 0.5 mm wide×0.004 mm thick×1 mm long.

ii) The specific gravity of the second sealant is 1.2 mg/mm³.

iii) The oxygen permeability of the second sealant (when the thickness is 1 mm) is 10 ml/m²/24 hrs·l atm.

iv) The second sealant contains 10 wt % deoxidant 61 having a deoxidizing capability of 30 ml/g=30 mm³/mg as a deoxidant 61.

From the condition i described above, a volume a of each second seal portion 60 provided is as follows:

$$α = 0.5 mm \times 0.004 mm \times 1 mm = 0.002 {mm}^{3} .$$

From the volume a and the condition ii described above, a weight β of the resin provided in each second seal portion 60 is as follows:

$$β = 0.002 {mm}^{3} \times 1.2 mg \text{/} {mm}^{3} = 0.0024 mg .$$

From the volume a and the condition iii described above, an oxygen permeability γ of the second seal portion 60 is as follows:

$$γ = 0.002 {mm}^{3} \times 10 ml \text{/} {m}^{2} \text{/} 24 hrs \cdot 1 atm \text{/} 1 mm = 0.02 {mm}^{3} \cdot ml \cdot 1 atm \div ( 1 , 000 , 000 {mm}^{2} \times 24 hrs \times 1 mm ) = 0.00000002 ml \cdot 1 atm \div ( 24 hrs ) = 0.00002 {mm}^{3} \text{/} 24 hrs \cdot 1 atm .$$

From the weight β and the condition vi described above, an oxygen absorption amount σ by the deoxidant 61 in the second seal portion 60 is as follows:

$$σ = 0.0024 mg \times 10 wt \% \times 30 {mm}^{3} \text{/} mg = 0.00024 mg \times 30 {mm}^{3} \text{/} mg = 0.0072 {mm}^{3} .$$

From the oxygen permeability and the oxygen absorption amount σ described above, a period of time D until the deoxidant 61 in the second seal portion 60 is saturated is as follows:

$$D = 0.0072 {mm}^{3} \div 0.00002 {mm}^{3} \text{/} 24 hrs \cdot 1 atm = 360 \times 24 hrs \cdot 1 atm .$$

As described above, according to the calculation under the conditions i to iv described above, the oxygen absorbability of the second seal portion 60 is maintained for 360 days under an atmospheric pressure of 1 atm. Occurrence of a display defect (spot) due to the impurity ions, in general, starts being observed 60 to 90 days later after the liquid crystal panel 10 is isolated, but, in the liquid crystal panel 10 according to the first embodiment, since arrival of oxygen at the first seal portion 50 is suppressed by providing the second seal portion 60, the time of occurrence of the display defect can be significantly retarded.

As described above, the liquid crystal panel 10 according to the first embodiment includes an array substrate (first substrate) 30, a CF substrate (second substrate) disposed opposite the array substrate 30 having a liquid crystal layer 40 therebetween, a first seal portion 50 formed from a first sealant containing a resin as a main component, and disposed around the liquid crystal layer 40, to bond the array substrate 30 and the CF substrate 20 together and seal the liquid crystal layer 40 between both the substrates 20, 30, and a second seal portion 60 formed from a second sealant containing a resin as a main component and having higher oxygen absorbability than the first sealant has, and disposed on an outer peripheral side of the liquid crystal panel 10 than the first seal portion 50 and between the substrates 20, 30.

According to the configuration of the first embodiment described above, since the second seal portion 60 composed of the second sealant having higher oxygen absorbability than the first sealant has is disposed nearer to the outer peripheral side than the first seal portion 50 is, oxygen reaching the first seal portion 50 is reduced, and therefore intrusion of oxygen into the first seal portion 50 is suppressed. In addition, even if impurity ions are generated by oxygen intruding into the second seal portion 60, since the first seal portion 50 is interposed between the second seal portion 60 and the liquid crystal layer 40, diffusion of the impurity ions into the liquid crystal layer 40 is suppressed. As a result, the occurrence of a spot due to oxygen intruding into the seal portion is suppressed, so that the occurrence of a defective product when the liquid crystal panel 10 is stored in a non-energized state for a long period of time can be reduced. Here, since the second sealant contains a resin as a main component like the first sealant, the second seal portion 60 can be easily formed by the same process as the first seal portion 50 is formed. The second sealant can be made to have high oxygen absorbability, for example, by adding the deoxidant 61 for absorbing oxygen. In a case where the deoxidant 61 is used, it is preferred that the concentration of the deoxidant contained in the first seal portion 50 be lower than the concentration of the deoxidant contained in the second seal portion 60, and it is further preferred that, like the first embodiment, the deoxidant 61 be not contained in the first seal portion 50. According to the configuration of the first embodiment, the second seal portion 60 containing the deoxidant 61 is not in contact with the liquid crystal layer 40, and the first seal portion 50 in contact with the liquid crystal layer 40 does not contain a deoxidant. Therefore, the deoxidant 61 can be selected without concern about pollution of the liquid crystal layer 40 due to migration of the deoxidant 61 or the like.

It is to be noted that, in the above description, the first seal portion 50 and the second seal portion 60 are not required to be provided independently from each other, and the first seal portion 50 and the second seal portion 60 may be formed as an integral seal portion. In such a case, an outer peripheral side (equivalent to the second seal portion 60) of the seal portion is configured to have higher oxygen absorbability than an inner peripheral side (a liquid crystal layer 40 side, equivalent to the first seal portion 50) thereof has. In a case where the deoxidant 61 is used, it is preferred that the concentration of the deoxidant 61 contained in the inner peripheral side of the seal portion be low, and it is further preferred that the deoxidant 61 be not contained at least in a portion in contact with the liquid crystal layer 40.

In the liquid crystal panel 10 according to the first embodiment, the first seal material and the second seal material contain a resin curable by a homogeneous external stimulus as a main component.

In the above description, the phrase “a homogeneous external stimulus” means an external stimulus of the same kind, such as heat or light, including external stimuli of the same kind which are different in curing temperature, effective wavelength, necessary heating time and/or exposure time, and/or the like. In the first embodiment, both the sealants contain as a main component a resin curable by irradiation with light.

According to the configuration of the first embodiment described above, since the first seal portion 50 and the second seal portion 60 can be formed by curing the first sealant and the second sealant by irradiation with light (by giving a single kind of external stimulus), the manufacturing process and necessary equipment for the liquid crystal panel is simplified so that a burden of operation management can be reduced. Though the external stimulus can also be heating or the like, irradiation with light is preferred in view of ease of operation management and a wide choice of materials, an/or the like, and UV irradiation is further preferred in view of availability of a conventional know-how. In addition, it is preferred that a resin having the same curing temperature and/or effective wavelength be used, since the burden of material procurement and/or management is reduced, and further simplification of the manufacturing process can also be achieved by curing the first sealant and the second sealant simultaneously by single light irradiation (giving a single external stimulus). From a similar point of view, it is further preferred that the same resin be used for the main component of the first sealant and the second sealant.

In the liquid crystal panel 10 according to the first embodiment, the second seal portion 60 is so extended as to close between both the substrates 20, 30 and as to have a closed ring-like shape as a whole all around the first seal portion 50 in a plan view.

According to the configuration of the first embodiment described above, since the second seal portion 60 is so disposed as to close between both the substrates 20, 30 and as to surround the first seal portion 50 entirely, oxygen of outside air will not directly intrude into the first seal portion. Therefore, intrusion of oxygen into the first seal portion 50 is effectively suppressed.

A method of manufacturing a liquid crystal panel 10 according to the first embodiment includes a first sealant application step of applying a first sealant containing a resin as a main component on to a mother array substrate (equivalent to a first substrate) 130 so as to form a closed-ring-like shape in a plan view, a second sealant application step of applying a second sealant containing a resin as a main component and having higher oxygen absorbability than the first sealant has on the mother array substrate 130 so as to be located on an outer peripheral side of the first sealant, and a seal portion formation step of forming a first seal portion 50 and a second seal portion 60 by curing the first sealant and the second sealant, with a mother CF substrate (equivalent to a second substrate) disposed oppositely on the mother array substrate 130 having the first sealant and the second sealant applied, to bond the mother array substrate 130 and the mother CF substrate together.

According to the above description, the liquid crystal panel 10 according to the first embodiment having the second seal portion 60 provided therein can be manufactured by a simple process. In the above description, the first sealant application step and the second sealant application step may be performed in any sequence. That is, after the second sealant application step, the first sealant may be applied to an inner peripheral side of the second sealant, or the first sealant and the second sealant may be applied simultaneously. In addition, in the seal portion formation step described above, the first sealant and the second sealant may be cured simultaneously, or either one of them may be cured ahead. It is preferred that the main component of the first sealant and the second sealant be a resin curable by the same external stimulus (for example, irradiation with UV having a specific wavelength, or the like) because the first seal portion and the second seal portion can be formed by curing both the sealants simultaneously only by giving a single external stimulus. This makes it possible to manufacture the liquid crystal panel 10 according to the first embodiment only by adding the second sealant application step, as compared with a method for manufacturing a display panel having a conventional configuration. Furthermore, it is further preferred that the main component of both the sealants be the same resin because material procurement and/or management is facilitated.

### Second Embodiment

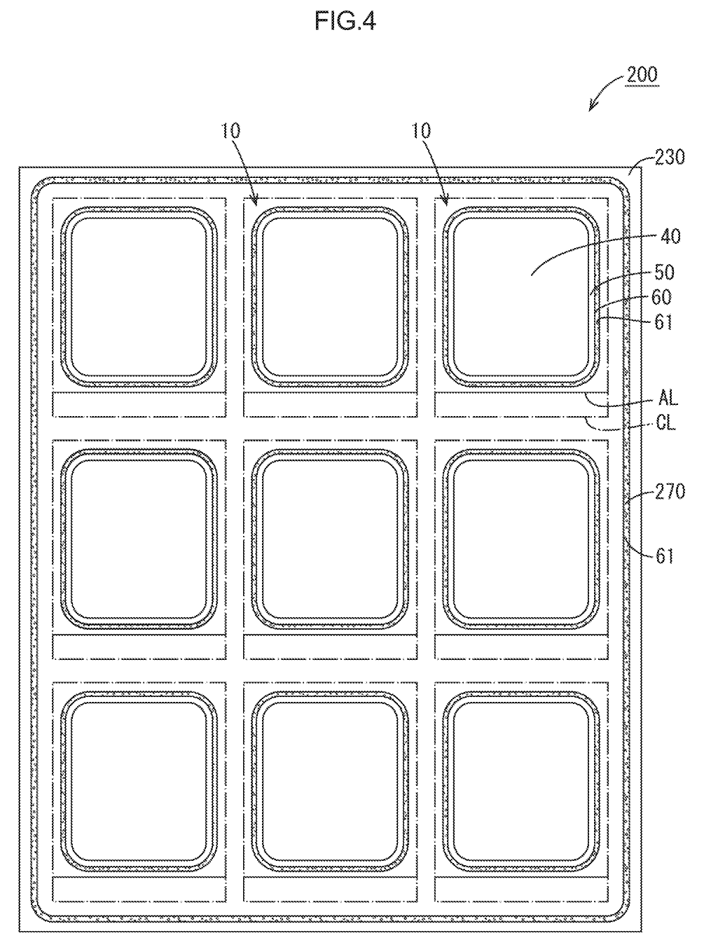

A second embodiment will be described with reference to FIG. 4. A collective liquid crystal panel 200 according to the second embodiment is different from the collective liquid crystal panel 100 according to the first embodiment in that a third seal portion 270 is formed along an outer peripheral end of the collective liquid crystal panel 200. In the following description according to the second embodiment, redundant descriptions of a configuration, an action and an effect similar to those of the first embodiment will be omitted (the same applies to a third embodiment).

FIG. 4 is a schematic view showing an outline of a plane configuration of the collective liquid crystal panel 200 according to the second embodiment. It is to be noted that, in FIG. 4, like FIG. 3, for the convenience of description, the collective liquid crystal panel 200 is depicted with illustration of the mother CF substrate disposed on the front side omitted. In the second embodiment, a third sealant is applied along an outer peripheral end of a mother array substrate 230, and collectively surrounds two or more first sealants and second sealants provided in a closed-ring-like shape at predetermined locations on the mother array substrate 230. The third sealant contains as a main component the same UV-curable epoxy resin as the first sealant and the second sealant, and is prepared by compounding the same deodixant 61 as compounded in the second sealant.

The collective liquid crystal panel 200 can be manufactured by a manufacturing method including a first sealant application step, a second sealant application step, a third sealant application step, and a seal portion formation step. The collective liquid crystal panel 200 according to the second embodiment can be manufactured by applying the third sealant, in addition to the first sealant, the second sealant, and the liquid crystal material, to the predetermined location described above on the mother array substrate 230, and thereafter performing UV irradiation with the mother CF substrate disposed oppositely in close contact with each sealant to cure each sealant to form the first seal portion 50, the second seal portion 60, and the third seal portion 270. Applying and curing the third sealant can be performed in a similar manner to the second sealant. After the collective liquid crystal panel 200 is produced, each liquid crystal panel 10 is isolated by cutting the collective liquid crystal panel 200 along the cutting lines CL (liquid crystal panel isolation step).

As described above, the collective liquid crystal panel (collective display panel) 200 according to the second embodiment is a collective liquid crystal panel 200 including two or more liquid crystal panels 10 contiguous to one another. The liquid crystal panel 10 includes the array substrate 30, the CF substrate 20 disposed opposite the array substrate 30 having the liquid crystal layer 40 therebetween, and a first seal portion 50 formed from a first sealant containing a resin as a main component, and disposed around the liquid crystal layer 40 to bond the array substrate 30 and the CF substrate 20 together and seal the liquid crystal layer 40 between both the substrates 20, 30, and between a mother array substrate (first mother substrate) 230 composed of the array substrates 30 contiguous to one another and a mother CF substrate (second mother substrate) composed of the CF substrates 20 contiguous to one another, a third seal portion 270 formed from a third sealant containing a resin as a main component and having higher oxygen absorbability than the first sealant has is disposed around the two or more liquid crystal panels 10 in a plan view.

According to the configuration of the second embodiment described above, since the third seal portion 270 is provided, intrusion of oxygen into the first seal portion 50 is suppressed. Since the third seal portion 270 is so formed as to surround the two or more liquid crystal panels 10 collectively in the collective display panel 200, the effect of suppression of oxygen intrusion into the first seal portion 50 can be achieved for the two or more liquid crystal panels 10 by a single structure. In the second embodiment, since the third seal portion 270 having a high oxygen absorbability is disposed along outer peripheral edges of the mother array substrate 230 included in the collective display panel 200, intrusion of oxygen into the first seal portions 50 of all the liquid crystal panels 10 formed within the collective display panel 200 is suppressed. Therefore, as compared with a case where the second seal portion 60 is provided for the individual liquid crystal panels 10, the configuration and process can be simplified, and it is useful for long-term storage of the collective display panel 200 itself before isolation of the liquid crystal panels 10, or the like. It is to be noted that the third sealant can be made by adding the deoxidant 61 for absorbing oxygen, and it is preferred that the third sealant contain a resin curable by an external stimulus of the same kind as the first sealant. In the second embodiment, the third sealant contains as a main component the same UV-curable epoxy resin as the first sealant, and compounded with the same deoxidant 61 as added in the second sealant. Furthermore, the third seal portion 270 according to the third embodiment is so extended as to close between the mother array substrate 230 and the mother CF substrate and as to have a closed-ring-like shape as a whole all around the first seal portions 50 in plan view. Therefore, intrusion of oxygen into the first seal portion 50 is effectively suppressed.

The collective liquid crystal panel (collective display panel) 200 according to the second embodiment is a collective liquid crystal panel 200 including two or more liquid crystal panels 10 according to the first embodiment contiguous to one another. A third seal portion 270 formed from a third sealant containing a resin as a main component and having higher oxygen absorbability than the first seal portion has is disposed around the two or more display panels in a plan view between a mother array substrate 230 including the array substrates 30 contiguous to one another and a mother CF substrate including the CF substrates 20 contiguous to one another.

According to the configuration of the second embodiment described above, since the second seal portion 60 and the third seal portion 270, which have high oxygen absorbability, are provided doubly, intrusion of oxygen into the first seal portion 50 is further suppressed.

A method for manufacturing a liquid crystal panel 10 according to the second embodiment includes a first sealant application step of applying two or more first sealants containing a resin as a main component on to a mother array substrate 230 so as to form a closed-ring-like shape in a plan view, a third sealant application step of applying a third sealant containing a resin as a main component and having higher oxygen absorbability than the first sealants have around the two or more first sealants, a seal portion formation step of forming first seal portions 50 and a third seal portion 270 by curing the first sealants and the third sealant, with a mother CF substrate disposed oppositely on the mother array substrate 230 having the first sealants and the third sealant applied, to bond the mother array substrate 230 and the mother CF substrate together to manufacture a collective liquid crystal panel 200 composed of two or more liquid crystal panels 10 contiguous to one another, and a display panel isolation step of isolating the two or more liquid crystal panels 10 by dividing the collective liquid crystal panel 200 after the seal portion formation step.

According to the above description, the collective liquid crystal panel 200 according to the second embodiment can be manufactured by a simple process, and the liquid crystal panel 10 can be manufactured from this collective liquid crystal panel 200. That is, since the third sealant is applied and cured, intrusion of oxygen into the first seal portion 50 with respect to the two or more liquid crystal panels 10 can be suppressed, so that the third seal portion 230 is useful for long-term storage of the collective liquid crystal panel 200 itself before isolation of the liquid crystal panel 10, or the like. In the above description, the first sealant application step and the third sealant application step may be performed in any sequence, or may be performed simultaneously. In addition, the first sealants and the third sealant may be cured simultaneously, or one of them may be cured ahead. It is preferred that the main component of the first sealants and the third sealant be a resin curable by the same external stimulus (for example, irradiation with UV having a specific wavelength, or the like) and that both the sealants be cured simultaneously to form the first seal portion and the third seal portion, and it is further preferred that the main component of both the sealants be the same resin, like the second embodiment.

It is to be noted that, in the second embodiment, the collective liquid crystal panel 200 provided with the first seal portion 50, the second seal portion 60, and the third seal portion 270 is formed by applying the second sealant to the outer peripheral side of the first sealant applied to two or more locations in the mother array substrate 230 so as to surround the individual first sealants, applying the third sealant additionally so as to surround the first sealants and the second sealants, and bonding the mother array substrate 230 to the mother CF substrate. Thereby, in a case where the collective liquid crystal panel 200 itself is stored for a long period of time, since the first seal portion 50 is surrounded doubly by the second seal portion 60 and the third seal portion 270 compounded with the deoxidant 61, intrusion of oxygen is effectively suppressed. Even after the liquid crystal panel 10 is isolated from the collective liquid crystal panel 200, since the first seal portion 50 remains surrounded by the second seal portion 60, so that intrusion of oxygen is suppressed. Here, in the second embodiment, the first seal portion, the second seal portion, and the third seal portion contain the same resin as a main component, and the second seal portion 60 and the third seal portion 270 are compounded with the same deoxidant 61. As a result, it is possible to obtain the collective liquid crystal panel 200 that has significantly improved oxygen resistance while facilitating material procurement and/or management and simplifying the manufacturing process and/or equipment.

### Third Embodiment

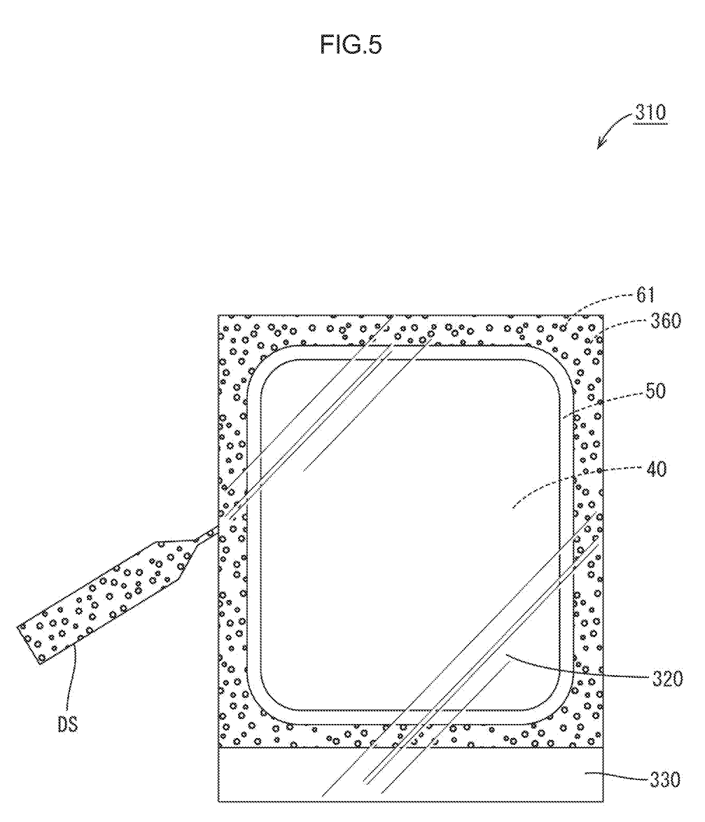

A third embodiment will be described with reference to FIG. 5. The third embodiment is different from the first embodiment in that a second seal portion 360 according to the third embodiment is not provided in the collective display panel, but provided in each liquid crystal panel 310 after the liquid crystal panel 310 is isolated from the collective display panel.

FIG. 5 is a schematic view depicting an outline of a plane configuration of an array substrate 330 according to the third embodiment isolated from the collective display panel.

The first seal portion 50 is provided in the liquid crystal panel 310, and thereby the array substrate 330 and a CF substrate 320 are bonded together. The first seal portion 50 is disposed more internally than an outer peripheral end of the liquid crystal panel 310 in plan view, and an air gap is formed between the array substrate 330 and the CF substrate 320 in an outer peripheral end face of the liquid crystal panel 310. The second sealant having higher oxygen absorbability than the first sealant has is injected into this air gap. A similar material to the material used in the first embodiment can be used for the second sealant. It is preferred that a resin curable by light irradiation be used for the second sealant in order not to impair the function of each structure formed in the liquid crystal panel 310. Though injection of the second sealant can be performed by any method, a method capable of precise discharge, such as a dispenser DS or an inkjet apparatus, is preferred. After the injection of the second sealant, by giving an external stimulus to cure the second sealant, the second seal portion 360 is formed around the first seal portion 50 sealing the liquid crystal layer 40.

As described above, a method for manufacturing a liquid crystal panel 10 according to the third embodiment includes a first sealant application step of applying two or more first sealants containing a resin as a main component on to a mother array substrate so as to form a closed-ring-like shape in a plan view, a first seal portion formation step of forming first seal portions 50 by curing the first sealants, with a mother CF substrate disposed oppositely on the mother array substrate having the first sealants applied, to bond the mother array substrate and the mother CF substrate together to manufacture a collective liquid crystal panel composed of two or more liquid crystal panels contiguous to one another, a display panel isolation step of isolating the two or more liquid crystal panels by dividing the collective liquid crystal panel after the first seal portion formation step, a second sealant application step of injecting a second sealant containing a resin as a main component and having higher oxygen absorbability than the first sealants have from an outer peripheral end face of the liquid crystal panel after the display panel isolation step, and a second sealant formation step of forming a second seal portion 360 on an outer peripheral side of the first seal portion 50 by curing the second sealant.

According to the configuration of the third embodiment described above, after the liquid crystal panel 310 is isolated, the second seal portion 360 for improving oxygen resistance of the individual liquid crystal panel 310 can be formed on an as-needed basis. Since the first sealant and the second sealant are applied and cured in separate steps, a compositional material of each sealant can be relatively freely selected. It is to be noted that the collective liquid crystal panel before isolation of the liquid crystal panel 310 may be provided with, for example, the third seal portion 270 formed in the second embodiment, or may be provided only with the first seal portion 50 sealing the liquid crystal layer 40 as a seal portion.

### Other Embodiments

The technology described herein is not limited to the embodiments described above with reference to the drawings. The following embodiments may be included in the technical scope.

(1) The technology described herein is also applicable to a variant display panel in which the planar shape of the display area and the liquid crystal layer is a square, a circle, an ellipse, or the like. In addition, the second seal portion can be formed in various shapes regardless of the shape of the first seal portion. The third seal portion can also be formed in various shapes without being restricted by the external shape of the first seal portion and/or the second seal portion, and/or the external shape of the collective display panel. For example, the third seal portion may be formed only around a partial area in the collective display panel.

(2) The technology described herein is also applicable to a liquid crystal panel having, for example, a shape bent in the middle and/or curved.

(3) For example, it is also possible to apply the sealants by means of transfer or the like in the first embodiment and the second embodiment, or to apply the sealants by means of vacuum injection or the like in the third embodiment.

(4) The liquid crystal material constituting the liquid crystal layer is not particularly limited. The technology described herein is useful for liquid crystal panels using various types of liquid crystal, such as nematic liquid crystal, cholesteric liquid crystal, or smectic liquid crystal. A driving method for the liquid crystal panel is not particularly limited, either.

(5) The technology described herein is applicable to a display panel, for example, an organic EL panel or the like, having functional molecules (medium layer) between a pair of substrates for displaying an image according to an orientational change of the functional molecules.

1. A display panel comprising:
a first substrate;
a second substrate disposed opposite the first substrate while having a liquid crystal layer therebetween;
a first seal portion formed from a first sealant containing a resin as a main component and disposed around the liquid crystal layer to bond the first substrate and the second substrate together and seal the liquid crystal layer between the first substrate and the second substrate; and
a second seal portion formed from a second sealant containing a resin as a main component and having higher oxygen absorbability than the first sealant has and disposed on an outer peripheral side of the display panel than the first seal portion and between the first substrate and the second substrate.

2. The display panel according to claim 1, wherein the first seal material and the second seal material contain a resin curable by a homogeneous external stimulus as a main component.

3. The display panel according to claim 1, wherein the second seal portion seals between the first substrate and the second substrate and extends all around the first seal portion in a plan view and form a closed-ring shape as a whole.

4. A collective display panel comprising:
a plurality of display panels contiguous to one another, one of the display panels includes
a first substrate,
a second substrate disposed opposite the first substrate while having a liquid crystal layer therebetween,
a first seal portion formed from a first sealant containing a resin as a main component and disposed around the liquid crystal layer to bond the first substrate and the second substrate together and seal the liquid crystal layer between the first substrate and the second substrate, and
a third seal portion formed from a third sealant containing a resin as a main component and having higher oxygen absorbability than the first sealant has, the third seal portion being disposed between a first mother substrate including first substrates contiguous to one another and a second mother substrate including second substrates contiguous to one another, and the third seal portion being disposed around the plurality of display panels in a plan view.

5. A collective display panel including a plurality of display panels according to claim 1, wherein
a third seal portion that is formed from a third sealant containing a resin as a main component and has higher oxygen absorbability than the first sealant has is disposed between a first mother substrate including first substrates contiguous to one another and a second mother substrate including second substrates contiguous to one another, the third seal portion being disposed around the plurality of display panels in a plan view.

6. A method of manufacturing a display panel comprising:
a first sealant application step of applying a first sealant containing a resin as a main component on a first substrate so as to form a closed-ring-like shape in a plan view;
a second sealant application step of applying a second sealant containing a resin as a main component and having higher oxygen absorbability than the first sealant has on the first substrate on an outer peripheral side of the first sealant; and
a seal portion formation step of forming a first seal portion and a second seal portion by curing the first sealant and the second sealant, with a second substrate disposed opposite the first substrate that has the first sealant and the second sealant applied thereon and bonding the first substrate and the second substrate together.

7. A method of manufacturing a display panel comprising:
a first sealant application step of applying a plurality of first sealants containing a resin as a main component on a first mother substrate so as to form a closed-ring-like shape in a plan view;
a third sealant application step of applying a third sealant containing a resin as a main component and having higher oxygen absorbability than the first sealants have around the plurality of first sealants;
a seal portion formation step of forming a first seal portion and a third seal portion by curing the first sealants and the third sealant, with a second mother substrate disposed opposite the first mother substrate having the first sealants and the third sealant applied, and bonding the first mother substrate and the second mother substrate together to manufacture a collective display panel including a plurality of display panels contiguous to one another; and
a display panel isolation step of isolating the plurality of display panels by dividing the collective display panel after the seal portion formation step.

8. A method of manufacturing a display panel comprising:
a first sealant application step of applying a plurality of first sealants containing a resin as a main component on a first mother substrate so as to form a closed-ring-like shape in a plan view;
a first seal portion formation step of forming first seal portions by curing the first sealants, with a second mother substrate disposed opposite the first mother substrate having the first sealants applied, and bonding the first mother substrate and the second mother substrate together to manufacture a collective display panel including a plurality of display panels contiguous to one another;
a display panel isolation step of isolating the plurality of display panels by dividing the collective display panel after the first seal portion formation step;
a second sealant application step of injecting a second sealant containing a resin as a main component and having higher oxygen absorbability than the first sealants have from an outer peripheral end face of the display panel after the display panel isolation step; and
a second sealant formation step of forming a second seal portion on an outer peripheral side of the first seal portion by curing the second sealant.
